(19) United States
(12) Patent Application Publication
(10) Pub. No.: US 2007/0219870 A1
(43) Pub. Date: Sep. 20, 2007

(54) Online Charging in Mobile Networks

(76) Inventors: Hans Ahlback, Turku (FI); Harri Hakala, Turku (FI); Matti Kuikka, Vahto (FI)

Correspondence Address: ERICSSON INC., 6300 LEGACY DRIVE, M/S EVR 1-C-11, PLANO, TX, 75024, US

(21) Appl. No.: 10/595,001

(22) PCT Filed: Jun. 18, 2003
(86) PCT No.: PCT/EP03/50235

§ 371 Date: May 17, 2007

(51) Int. Cl. G06Q 30/00

(52) U.S. Cl. 705/26

(57) ABSTRACT

A method of using accounting certificates to allow a subscriber of a home network to purchase services or products via a mobile communications network, the method comprising sending a request for an accounting certificate from a subscriber's mobile terminal to a certificate issuing node, upon receipt of the request at said node, sending an authorisation request from said node to an online charging system of the subscriber's home network, at the online charging system, making a decision on said request based upon the subscriber's account data, and returning either an accept or deny service request message to said node, in the event that an accept service request message is received by said node, sending the requested accounting certificate to the subscriber terminal, and sending the accounting certificate from the subscriber terminal to the provider of a product or service to be paid for.

### FIELD OF THE INVENTION

The present invention relates to online charging in mobile communication networks and more particularly to the use of accounting certificates for online charging.

### BACKGROUND TO THE INVENTION

In the near future, the use of electronic cash to pay for products and services is likely to become widespread. In many cases, electronic cash will be issued by banks. However, where payments are to be made using a mobile communication device, it may be convenient for the electronic cash to be issued by a subscriber's home network operator. This is true especially where the subscriber is paying for a service which is accessed using his or her mobile communication device, e.g. the downloading of data from an Internet server to the device, for viewing by the subscriber. The amount of electronic cash provided to a subscriber can be added to that subscriber's bill, or deducted from a credit account in the case of pre-paid subscribers.

The Third Generation Partnership Protocol (3GPP) is involved in the ongoing development of standards for third generation mobile cellular networks. One aspect of this ongoing work is the handling of the issuing, use, and management of subscriber certificates (see 3GPP TS ab.cde V0.2.0 (2003-05)). Subscriber certificates are issued in order to authorize and account for service usage both in home and in visited network. A subscriber certificate can be for example one of the following types:

authorization certificate

authentication certificate

accounting certificate

The use of accounting certificates in particular is intended to make it possible for a user to use chargeable services, e.g. via the Internet. Accounting certificates may be short-lived certificates which are valid for a relatively short time period and can be used only once. These certificates do not require complex and expensive management systems for checking their validity, but at the same time keep the risks of fraud low. As yet there is no clearly defined mechanism (within the 3GPP proposals or standards) regarding how to control the payment/charging flow when an accounting certificate is issued and used.

### SUMMARY OF THE INVENTION

It has been identified that there is a need to link the use of accounting certificates to existing network charging mechanisms used by mobile network operators.

According to a first aspect of the present invention there is provided a method of using accounting certificates to allow a subscriber of a home network to purchase services or products via a mobile communications network, the method comprising:

sending a request for an accounting certificate from a subscriber's mobile terminal to a certificate issuing node;

upon receipt of the request at said node, sending an authorisation request from said node to an online charging system of the subscriber's home network;

at the online charging system, making a decision on said request based upon the subscriber's account data, and returning either an accept or deny service request message to said node;

in the event that an accept service request message is received by said node, sending the requested accounting certificate to the subscriber terminal; and

sending the accounting certificate from the subscriber terminal to the provider of a product or service to be paid for.

The online charging system to which said authorisation request is sent is responsible for coordinating all charges made against subscribers of the home network. Upon receiving an authorisation request, and upon acceptance of that request, the online charging system may make a credit reservation against the subscriber's account for the value of the accounting certificate.

Said certificate issuing node is preferably owned by the operator of the access network used by the subscriber terminal. That access network may be provided by the operator of the subscriber's home network, or may be provided by a visited network.

Preferably, said certificate issuing node comprises a Public Key Infrastructure portal, which uses shared secret keys to communicate with a subscriber terminal. More preferably, the Public Key Infrastructure portal communicates with a Bootstrapping Server Function of the subscriber's home network to obtain a shared secret previously agreed between the Bootstrapping Server Function and the subscriber terminal. The Public Key Infrastructure portal preferably obtains the shared secret after receiving a request for an accounting certificate from the subscriber terminal. The Bootstrapping Server Function may also notify the Public Key Infrastructure portal of the subscriber's rights to obtain accounting certificates.

In certain embodiments, the provider of a product or service sends an invoice to the subscriber terminal for products or services which the subscriber proposes to purchase. After receipt of this invoice, the subscriber terminal sends the request for the accounting certificate to the certificate issuing node. In other embodiments, the request is sent, and optionally the certificate returned to the subscriber terminal, prior to receipt of the invoice at the terminal.

Preferably, the provider of a product or service to be paid for sends received accounting certificates to said certificate issuing node for settlement. This may be sent together with an invoice signed by the subscriber. Upon receipt of this information, the certificate issuing node may inform said online charging system of the consumption of the issued accounting certificate, and the online charging system then updates the subscriber's account data.

In a typical embodiment of the invention, the provider of the service maintains a server which receives accounting certificates from subscriber terminals. The server is attached to an IP network, e.g. the Internet, and communicates with the subscriber terminal and said certificate issuing node via that IP network. The server may be operated by the subscriber's home network or, in the case of a roaming subscriber, by the visited network. Alternatively, the service provider may be external to the home or visited network, but have a billing relationship with the home or visited network.

Preferably, said accounting certificate is secured by bootstrapping on an authentication and shared secret agreement procedure performed between the mobile terminal and the subscriber's home network. More preferably, this procedure is the Authentication and Key Agreement (AKA) procedure.

According to a second aspect of the present invention there is provided a Network Application Function node for use in a mobile communications system, the node having an interface towards one or more online charging functions, each online charging function coordinating charges for subscribers of a home network to which the online charging function belongs, an interface towards one or more product or service providers, and an interface towards subscribers wishing to purchase products or services made available by said providers, the node further comprising:

means for receiving from a subscriber an accounting certificate request;

means for sending an authorisation request from said node to an online charging system of the subscriber's home network;

means for receiving an accept or deny request from said online charging function; and

means for sending the requested accounting certificate to the subscriber terminal in the event that an accept service request message is received by the node.

### BRIEF DESCRIPTION OF THE DRAWINGS

FIG. 1 illustrates schematically a mobile telecommunications system in which a mobile subscriber is roaming in a visited network; and

FIG. 2 illustrates signalling associated with the purchase of a service by the mobile subscriber using an accounting certificate.

### DETAILED DESCRIPTION OF CERTAIN EMBODIMENTS

There will now be described a method for associating the use of accounting certificates as proposed for 3GPP, with existing 3GPP online charging mechanisms, thus making it possible for a mobile subscriber to use the issued certificates to pay for services/products not necessarily controlled by the subscriber's home operator. To minimize the financial risk for all involved parties, it is proposed that the issuing and use of accounting certificates is coupled directly to the user's charging account within the home network, by means of real time credit control mechanism.

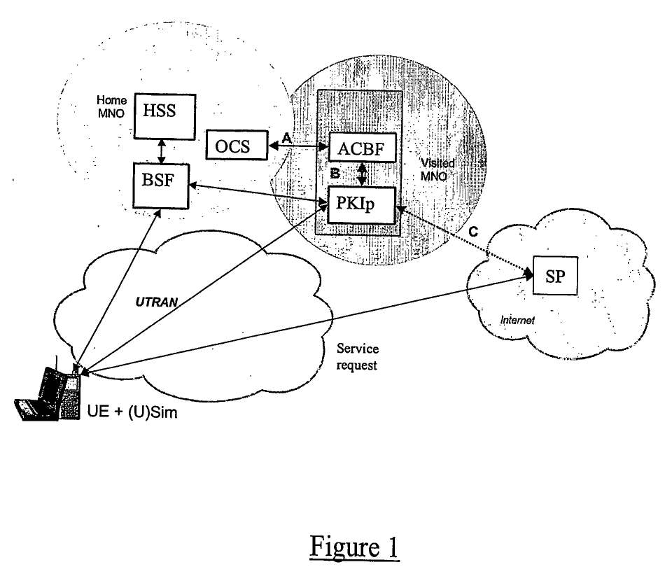

FIG. 1 illustrates schematically a mobile communications system in which a mobile subscriber using a mobile terminal or UE 1 is roaming in a visited UMTS network. The terminal 1 is attached to a radio access network (UMTS Terrestrial Radio Access Network, UTRAN) 2. Through this access network, the mobile subscriber is able to make voice and data calls and request multimedia services, and access data services. In particular, the subscriber is able to connect to the Internet 3, for example to communicate with an online merchant or service provider (SP). This merchant operates a server 4 from which the subscriber may download information for a fee. For example, for a fee of 1 [symbol] , the subscriber may download a map of a town or city.

The online merchant has a billing arrangement with the operator of the visited network, but not with the operator of the subscriber's home network. That is to say that the merchant will trust accounting certificates issued by the visited network but not by the home network. To pay for a requested service, the mobile subscriber must obtain an accounting certificate from the visited network. An alternative reason for the online merchant requiring certificates issued by the visited network is to avoid complex cross-certificates and management of the cross-certificates. To make certificates widely available, the PKI portals (Certification Authorities) must issue cross-certificates for each other, so that the user can use his/her certificates in other domain as well as well as his/her home domain. In the scenario considered here (i.e. mobile operator as PKIp), to avoid having to issue cross-certificates between operators, it may be easier to use only the visited network operator's certificates, since local online merchants can easily recognise these certificates.

FIG. 1 illustrates an accounting certificate issuing node, referred to here as the Network Access Function (NAF) node 5, which is owned by the operator of the visited network, the visited Mobile Network Operator (MNO). The NAF 5 comprises a Public Key Infrastructure portal (PKIp) 6 and an Accounting Certificate Broker Function (ACBF) 7. [PKI refers to a “system” of certification authorities, and optionally registration authorities and other supporting servers, that perform certificate management, archive management, key management, certificate distribution and token management functions for a community of users. For further details see IETF RFC 2510.] Whilst a NAF comprising a PKIp is introduced in the current 3GPP proposals (see 3GPP TS ab.cde V0.2.0 (2003-05)), the ACBF is a new function. The ACBF 7 acts as a “broker” between the PKIp 6 and the Online Charging System (OCS) 8 in the user's home network 9. The OCS 8 (see 3GPP TS 32.200 Charging Management; Charging Principles) is responsible for collecting all charging information associated with a given subscriber of the home network, including call charges, data charges, and charges incurred as a result of the purchase of products or services. The OCS maintains account data (credit/debit) for subscribers, e.g. for prepaid subscribers.

With respect to the 3GPP network architecture, new interfaces are introduced between the ACBF 7 and the OCS 8 (interface A), between the ACBF 7 and the PKIp 6 (interface B), and between the ACBF 7 and the online merchants 4 (interface C). Apart from these interfaces and the ACBF, all entities and interfaces either already exist in 3GPP (Rel-5) or about to be introduced in Rel-6: BSF and NAF (as PKI portal) for bootstrappping of subscriber certificates (by 3GPP SA3), OCS for online Charging Architecture (by 3GPP SA5).

The PKIp 6 uses the ACBF 7 to perform a credit check on the account from where money will be reserved for an issued accounting certificate, and also to withdraw the reserved monetary amount when service is delivered and transaction evidence is received from the service provider. It is proposed that communications over the A interface use the so-called Ro interfaces specified in 3GPP TS 32.200, Charging Management; Charging Principles, which is based on the Diameter Credit-control application.

In a typical scenario, a subscriber accesses an Internet page of the online merchant 4. The subscriber identifies a product or service which he wishes to purchase. The merchant sends an invoice for the appropriate amount to the subscriber's terminal 1. At this point, or possibly earlier, an AKA bootstrapping procedure (see 3GPP TS 33.102, 3G Security; Security Architecture) is performed between the terminal 1 and a Bootstrapping Server Function (BSF) 10 of the subscriber's home network. This establishes a shared secret between the terminal 1 and the BSF 10.

Upon receipt of a request from the UE, the PKIp first contacts the BSF 10 of the subscriber's home network to obtain the address of the responsible OCS (this is obtained by the BSF from the HSS in the home network) and the (AKA) shared secret. At this point in time, the home network may make a decision that accounting certificates cannot be issued to the requesting subscriber, e.g. to prevent a certain subscriber from accessing a premium rate service. Any such decision is communicated to the PKIp, whereupon the procedure is terminated and the terminal 1 notified. However, assuming that no such bar is placed on the subscriber by the home network, the ACBF will contact the OCS (interface A) in the home network. The correct OCS can be located based upon information provided by the subscriber profile. The OCS performs a credit check on the subscriber. Assuming that the subscribers account has sufficient credit in his account, a credit reservation based on the information supplied by the service provider is made at the OCS 8. If necessary, at this point the home operator can place restrictions on service use in case for example there is not enough credit in a subscriber's account. This decreases the financial risk to the home operator.

An accept request message is signalled from the OCS 8 to the ACBF 7. An Accounting Certificate can then be issued by the PKI portal and sent to the UE 1. The certificate is secured using the shared secret obtained by the PKIp from the BSF such that the terminal is able to verify the authenticity of the certificate. The certificate may also be signed with a private key (of a private-public key pair) of the PKIp. When the subscriber has consumed some service and signed the related invoice, this is sent by the UE 1 to the online merchant 4 together with the accounting certificate. The online merchant authenticates the certificate, e.g. using the public key of the PKIp. The PKIp 6 will receive the signed invoice together with the accounting certificate from the merchant (interface C). The PKIp 6 relays the information to the ACBF 7 which reports consumption information to the OCS 8. The ACBF 7 can also generate a record containing the accounting certificate and the signed invoice (as evidence of the transaction). These records can later be used for handling settlements, both towards the merchant and towards the home operator of the subscriber.

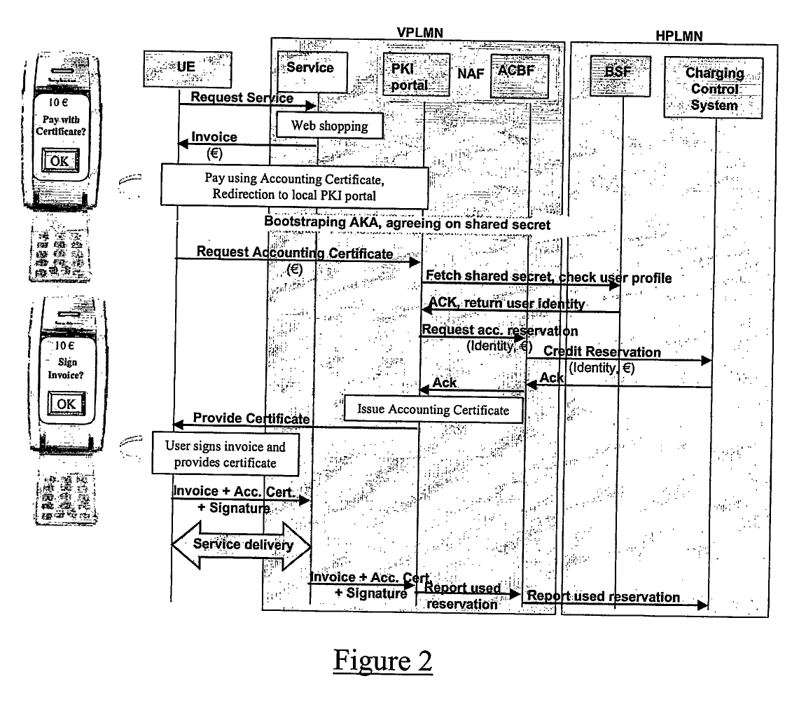

FIG. 2 is a sequence diagram showing signalling between the involved entities for issuing and using accounting certificates.

Payment transactions between the online merchant and the local operator (PKIp) are not included in the sequence diagram. These payments are assumed to take place via ‘off-line’ transactions, based on predefined agreements between the service provider and the operator.

It is expected that online merchants will find the solution presented here more attractive than solutions where they (the merchants) have to collect the money directly from the subscribers. The use of accounting certificates is especially relevant for micro payments (up to 10 [symbol] ), but due to the high security connected with the use of certificates, the method presented can also be considered to use them for macro payments (above 10 [symbol] ).

Due to the nature of certificates (high security, short-lived validity etc.), they are considered to be safer and less open to fraud than credit card use. Consequently, it is expected that subscribers will be more willing to use short-lived accounting certificates than to reveal personal credit card details to unknown parties, especially when using local services in roaming scenarios.

1. A method of using accounting certificates to allow a subscriber of a home network to purchase services or products via a mobile communications network, the method comprising:
sending a request for an accounting certificate from a subscriber's mobile terminal to a certificate issuing node;
upon receipt of the request at said node, sending an authorisation request from said node to an online charging system of the subscriber's home network;
at the online charging system, making a decision on said request based upon the subscriber's account data, and returning either an accept or deny service request message to said node;
in the event that an accept service request message is received by said node, sending the requested accounting certificate to the subscriber terminal; and
sending the accounting certificate from the subscriber terminal to the provider of a product or service to be paid for.

2. The method according to claim 1, wherein said online charging system to which said authorisation request is sent is responsible for coordinating all charges made against subscribers of the home network.

3. The method according to claim 1, said certificate issuing node being owned by the operator of the access network used by the subscriber terminal.

4. The method according to claim 3, wherein the access network is provided by the operator of the subscriber's home network, or by a visited network.

5. The method according to claim 1, wherein said certificate issuing node comprises a Public Key Infrastructure portal, which uses shared secret keys to communicate with a subscriber terminal.

6. The method according to claim 5, wherein the Public Key Infrastructure portal communicates with a Bootstrapping Server Function of the subscriber's home network to obtain a shared secret previously agreed between the Bootstrapping Server Function and the subscriber terminal.

7. The method according to claim 6, wherein the Public Key Infrastructure portal preferably obtains the shared secret after receiving a request for an accounting certificate from the subscriber terminal.

8. The method according to claim 1, wherein the Public Key Infrastructure portal communicates with the subscriber's home network to obtain the identity of the responsible online charging system prior to sending said authorisation request, and/or for authorisation to issue accounting certificates in principle.

9. The method according to claim 1, wherein the provider of a product or service to be paid for, sends received accounting certificates to said certificate issuing node for settlement.

10. The method according to claim 1, wherein the online charging system reports previously reserved credit as used and withdrawn, when a service has been delivered and a signed invoice received from the service provider.

11. The method according to claim 1, wherein the provider of a product or service sends an invoice to the subscriber terminal for products or services which the subscriber proposes to purchase and, after receipt of this invoice, the subscriber terminal sends the request for the accounting certificate to the certificate issuing node.

12. The method according to claim 1, wherein the request for an accounting certificate is sent prior to receipt of the invoice at the terminal.

13. The method according to claim 1, wherein said accounting certificate is secured by bootstrapping on an authentication and shared secret agreement procedure performed between the mobile terminal and the subscriber's home network.

14. A Network Application Function node for use in a mobile communications system, the node having an interface towards one or more online charging functions, each online charging function coordinating charges for subscribers, of a home network to which the online charging function belongs, an interface towards one or more product or service providers, and an interface towards subscribers wishing to purchase products or services made available by said providers, the node further comprising:
means for receiving from a subscriber an accounting certificate request;
means for sending an authorisation request from said node to an online charging system of the subscriber's home network;
means for receiving an accept or deny request from said online charging function; and means for sending the requested accounting certificate to the subscriber terminal in the event that an accept service request message is received by the node.
